(19) United States
(12) Patent Application Publication
(10) Pub. No.: US 2016/0275497 A1
(43) Pub. Date: Sep. 22, 2016

(54) CURRENCY PRICING AND SETILEMENT

(71) Applicant: The Royal Bank of Scotland Group plc, Edinburgh (GB)

(72) Inventors: On Kam Kenny CHIU, Stamford, CT (US); Ronald Joseph KARPOVICH, London (GB)

(21) Appl. No.: 15/008,830

(22) Filed: Jan. 28, 2016

Related U.S. Application Data
(63) Continuation of application No. 13/906,911, filed on May 31, 2013, now abandoned.

(51) Int. Cl. G06Q 20/38; G06Q 20/10

(52) U.S. Cl. CPC G06Q 20/381; G06Q 20/10

(57) ABSTRACT

A computerized system including a first processor to determine a difference between an actual settlement and a respective expected settlement for each of a plurality of client transactions, each client transaction having an expected settlement in a first currency and a transaction price in a second currency under which the transaction is performed, the transaction price being determined from the expected settlement using a respective time-limited guaranteed exchange rate between the first and second currencies, and each actual settlement in the first currency being determined from the transaction price using a third party exchange rate, such that for each client transaction any difference between an actual settlement and a respective expected settlement is at least in part due to a difference between the time-limited guaranteed exchange rate and the third party exchange rate; and a second processor to adjust, for each client transaction, a respective client account balance according to said difference.

### CROSS-REFERENCE TO RELATED APPLICATIONS

This application is a continuation under 35 U.S.C. §120 of U.S. patent application Ser. No. 13/906,911, filed May 31, 2013. The entire contents of this application are hereby incorporated in full by reference.

### BACKGROUND OF THE INVENTION

1. Field of the Invention

The present invention relates to foreign currency exchange and, in particular, but not exclusively, to computerised systems and processes involved with foreign exchange transactions and/or transaction settlements.

2. Description of the Related Technology

The Internet and more particularly the World Wide Web (www) have over the past decade facilitated a dramatic growth in E-commerce. E-commerce, in technical terms, can cross international boundaries and many sellers (for example, online merchants) nowadays offer their products to buyers who are based in other countries. A foreign exchange (FX) transaction is typically required in cross-border transactions where the respective countries of the buyer and seller have different local currencies, or where the chosen currency of the buyer is different from the selected operating currency of the seller; where either or both currencies may be the respective local currencies of the buyer and seller.

By ‘FX transaction’ we mean a currency trade in which one currency is exchanged for another, for example the local currency of a buyer is exchanged for the operating currency of a seller. Effectively, the local currency of the buyer is sold and the operating currency of the seller is purchased, where the amount of the operating currency that is purchased is determined by an exchange rate for the currency pair. In this way, a buyer can buy products using one currency while the seller can be paid in another currency. The exchange rate may be taken from (or determined based on) various known public or FX market sources.

The actual FX transaction may in principle be performed by any one of various parties or intermediaries who are involved in a known payment pipeline. For example, if the buyer uses a payment card (such as a credit card having as a denominated currency the local currency of the buyer), a card issuer (which, for example, issued the card to the buyer) may perform the FX transaction on receipt of an associated payment request from the seller (or its card acquiring bank). Alternatively, an acquiring bank acting for the seller may receive payment from the card issuer, in the local currency of the buyer and perform the FX transaction in order to credit the funds, in the operating currency of the seller, into the seller's respective bank account. Alternatively, a card scheme (for example, VISA, Amex or MasterCard) under which a card is issued may perform the FX transaction. Further, the FX transaction may be performed by an intermediary, which handles FX transactions for acquiring banks (or acquirers), card issuers, card schemes or any other party that requires such a service.

It will be appreciated that the foregoing payment principles apply equally to foreign money transfers, in which a party in one country wishes to send funds to a party in another country, as well as to other known online and/or cross border transactions.

A problem with the foregoing scenario is that the buyer typically does not know, at the point of payment by the buyer, exactly how much they will pay for their online purchase, and, typically, none of the parties mentioned are normally willing to take-on exchange rate risk by guaranteeing advance fixed exchange rates, since the exchange rate may change downstream in the pipeline, between the point of payment and the time when the FX transaction actually takes place. The time delay between the point of payment and the time when the FX transaction actually takes place may be minutes but more likely hours or even days, during which time exchange rates can vary significantly. Therefore, in essence, the buyer (rather than the seller or their acquiring bank, card issuer, card scheme or selected intermediary) cannot know exactly how much the transaction will cost them at the point of payment and effectively has to accept the currency exchange risk in this kind of scenario. Due to the uncertainty, some buyers may be deterred from performing cross-border transactions.

In another scenario, systems are known to perform Dynamic Currency Conversion (DCC), whereby, at the point of payment by the buyer, a seller can offer the buyer the choice of making the purchase in the buyer's local currency or in the seller's operating currency. However, such systems typically only offer the currency choice at checkout, which is often after a buyer has committed to a purchase. For example, if the purchase is a meal in a restaurant (e.g. when on holiday in a foreign country), the buyer has already committed to the purchase (i.e. they have eaten the meal) when payment is required at the end of the meal.

In another known scenario, the currency exchange risk is taken on by an intermediary, which operates what is referred to herein as an advance currency pricing (ACP) system. Such a system is known to provide time-limited guaranteed (TLG) exchange rates to sellers, for example, so that the sellers can provide guaranteed pricing to buyers (for example, in their local currency), either before or at the point of payment by the buyer, and receive an associated guaranteed or expected settlement (for example, in the seller's chosen operating currencies). ACP systems as such typically also perform the associated FX transaction, for example, on behalf of the seller, their acquirer, the associated payment card issuer or the card scheme.

A benefit of ACP systems, in providing guaranteed exchange rates, is that sellers can with a low degree of risk offer multi-currency pricing (MCP), whereby products can be priced in any supported local currency of potential buyers. This greatly increases certainty to buyers, since they know exactly how much they will pay at the point of payment before committing to a purchase, and, equally, the sellers will know how much money, in their operating currency, they will receive when the transaction is finally settled (subject of course to the deduction of any standard card fees or the like that arise in a known payment pipeline). An example of a known ACP system is described in U.S. Pat. No. 7,587,362. Systems of this kind which are involved in advance currency pricing and are also involved in performing the FX transaction and settlement will for convenience be referred to herein as advance currency pricing and settlement (ACPS) systems.

### SUMMARY

An aspect of the present invention provides a computerised system comprising:

a first processor to determine a difference between an actual settlement and a respective expected settlement for each of a plurality of client transactions, each client transaction having an expected settlement in a first currency and a transaction price in a second currency under which the transaction is performed, the transaction price being determined from the expected settlement using a respective time-limited guaranteed exchange rate between the first and second currencies, and each actual settlement in the first currency being determined from the transaction price using a third party exchange rate, such that for each client transaction any difference between an actual settlement and a respective expected settlement is at least in part due to a difference between the time-limited guaranteed exchange rate and the third party exchange rate; and

a second processor to adjust, for each client transaction, a respective client account balance according to said difference.

Another aspect of the present invention provides an advance currency pricing system, comprising:

a generator to generate time-limited guaranteed exchange rates for clients;

an advance currency pricing and compensation processor, comprising:

a first processor to determine a difference between an actual settlement and a respective expected settlement for each of a plurality of client transactions, each client transaction having an expected settlement in a first currency and a transaction price in a second currency under which the transaction is performed, the transaction price being determined from the expected settlement using a respective time-limited guaranteed exchange rate between the first and second currencies, and each actual settlement in the first currency being determined from the transaction price using a third party exchange rate, such that for each client transaction any difference between an actual settlement and a respective expected settlement is at least in part due to a difference between the time-limited guaranteed exchange rate and the third party exchange rate; and

a second processor to adjust, for each client transaction, a respective client account balance according to said difference; and

an advance currency pricing and settlement processor, comprising:

a first processor to receive information relating to a client transaction comprising a transaction price in a second currency, determined from a base price in a first currency using a time-limited guaranteed exchange rate;

a second processor to perform at least one foreign exchange transaction between first and second currencies to accommodate said client transaction; and

a third processor to debit a first client account according to the transaction price in the second currency and credit a second client account according to the base price in the first currency.

Another aspect of the present invention provides method of settling client transactions, comprising:

determining a difference between an actual settlement and a respective expected settlement for each of a plurality of client transactions, each client transaction having an expected settlement in a first currency and a transaction price in a second currency under which the transaction is performed, the transaction price being determined from the expected settlement using a respective time-limited guaranteed exchange rate between the first and second currencies, and each actual settlement in the first currency being determined from the transaction price using a third party exchange rate, such that for each client transaction any difference between an actual settlement and a respective expected settlement is at least in part due to a difference between the time-limited guaranteed exchange rate and the third party exchange rate; and

adjusting, for each client transaction, a respective client account balance according to said difference.

### BRIEF DESCRIPTION OF THE DRAWINGS

Further aspects, embodiments, features and advantages of the invention will become apparent from the following description of embodiments of the invention, given by way of example only, which is made with reference to the accompanying drawings, of which:

FIG. 1 is a schematic block diagram of a payment system according to one exemplary embodiment of the present invention;

FIG. 2 is a flow diagram illustrating a payment process conducted in the exemplary payment system of FIG. 1;

FIGS. 3 to 5 are schematic block diagrams highlighting different specific operating elements of an exemplary ACPS system;

FIG. 6 is a schematic block diagram of an alternative arrangement according to embodiments of the present invention; and

FIG. 7 is a schematic block diagram of another alternative arrangement according to embodiments of the present invention.

### DETAILED DESCRIPTION OF CERTAIN INVENTIVE EMBODIMENTS

In arriving at the present invention it has been appreciated that known kinds of ACPS system cannot be utilised efficiently in certain scenarios. One such scenario is when a seller, such as an online merchant, uses a third party (for example, a card scheme), which does not itself offer advance currency pricing, to perform its FX transactions. Embodiments of the present invention provide a new kind of ACP system, which accommodates such scenarios.

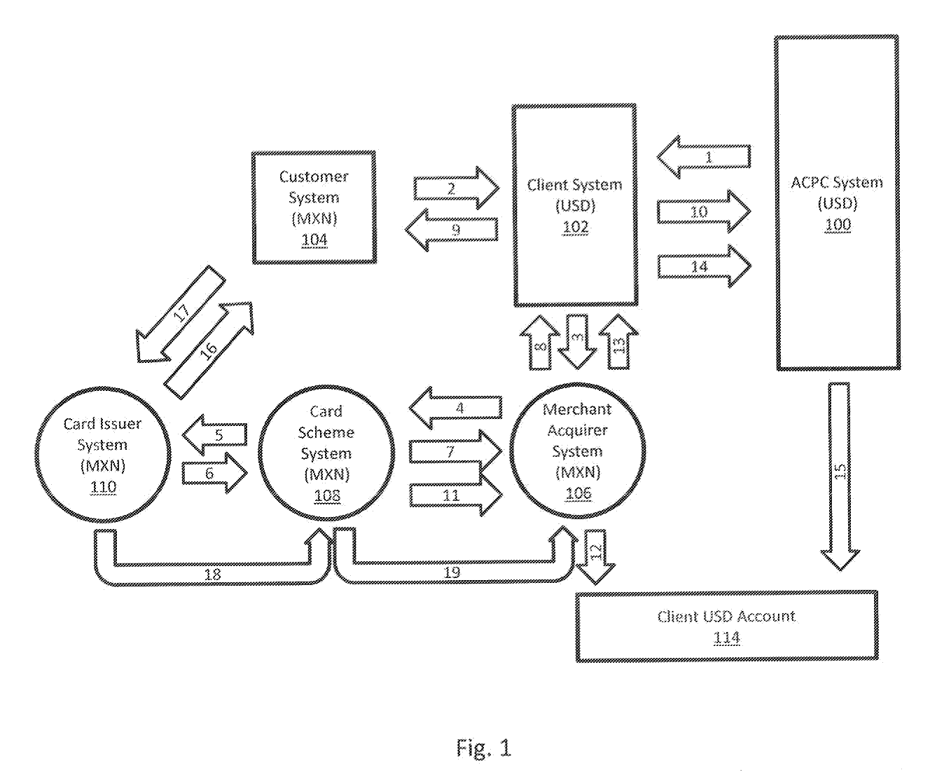

The operation of the new kind of ACP system will now be described in the context of an overall transaction system as will now be described with reference to the diagram in FIG. 1.

A system according to embodiments of the present invention may be thought of as ACP system since it provides TLG exchange rates to clients, by which the clients can advertise products online to customers in foreign currencies. However, a system according to embodiments of the present invention differs from known kinds of ACPS system insofar as it typically does not perform FX transactions and/or settlements for clients. Instead, the system operates to provide TLG exchange rates and affords the same degree of assurance as a known ACPS system by undertaking to compensate a client if there is a shortfall in actual settlement delivered by a third party (using a respective third party exchange rate to perform the FX transaction) compared with a respective expected settlement determined using the TLG exchange rate. For convenience only, embodiments of the present invention will hereafter refer to advance currency pricing and compensation (ACPC) systems, which do not perform FX transactions but act instead to compensate if a shortfall in settlement arises. As will become apparent, according to some embodiments, ACPC systems, processes and methods can provide functions other than compensation, and the term ACPC is used merely for convenience and should not therefore be construed in any way to limit the kinds of operations that can be performed by such as system.

FIG. 1 illustrates an exemplary ACPC system 100, which provides TLG exchange rates to client systems 102 (only one of which is illustrated for convenience).

Both the ACPC system 100 and the client system 102 (and, more broadly, other systems described hereinafter) typically comprise, respectively, at least one computing device, platform or apparatus running known operating systems (e.g. Linux™, Unix™ or Windows™), or virtual operating systems, and being programmed with application software to operate according to embodiments of the present invention. It will be appreciated that different functions may be performed on a single computing device, platform or apparatus or may be distributed between plural communicatively-coupled computing devices, platforms and/or apparatuses in the same location or in different locations. The systems typically communicate and interact with one another via known communications networks, for example private networks or public communications networks such as the Internet. In the latter case, suitable data encryption and/or VPN technology is typically employed. In other embodiments, a system may comprise software operating on a computing device, platform or apparatus, for example, shared with other programmes or systems. The skilled person will appreciate that the particular architecture chosen is purely a matter of design choice.

In the present example, a ‘client’ is a party that uses the ACPC system 100, for example an online merchant or foreign exchange money transfer bureau. In this example, the client system 102 employs USD as its operating currency.

The following terms will be used in the description that follows:

Base price—the price of a product/service expressed in the operating currency of a client (or equivalent). The operating currency of the client may instead be referred to as the ‘first’ currency.

Transaction price—the price of the product/service expressed in the local currency of a customer of the client after conversion from the base price using a TLG exchange rate. The local currency of the customer may instead be referred to as the foreign currency or the ‘second’ currency. ‘Foreign’ in this context merely means a different currency from the operating currency of the client.

Expected settlement—the value of a settlement expected by the client (and guaranteed by an ACPC system) in the operating currency of the client. The expected settlement may be determined by converting the transaction price back into the operating (or first) currency of the client using the TLG exchange rate. The expected settlement is typically the same as the base price, unless the client expects to receive a reduced settlement (relative to the base price) due to the associated transaction having incurred one or more charges (as will be described). Indeed, the expected settlement may match the funds that are credited into a client account, or may be more or less than the funds that are credited into a client account, depending, for example, on whether charges and the like are factored into the expected settlement.

Actual settlement—the value of a settlement received by the client in the operating currency of the client from a third party after the transaction price has been exchanged for the operating currency of the client using a third party exchange rate. As will be described, the actual settlement may accommodate certain charges incurred within a payment pipeline, in addition to the third party exchange rate, or may just reflect the third party exchange rate.

The client system 102 is typically arranged to advertise products online to, and accept online transaction requests from, customer systems 104. The client system 102 can apply the TLG exchange rates to its base product prices (specified in the operating currency of the client) to price and advertise its products in the local currency of a prospective customer, which in this example is in Mexican Pesos (MXN). According to the present example, the base prices, in the operating currency of the client, are set to be the same as the expected settlements for the respective sales.

In the present example the customer system 104 may be a personal computer or mobile computing device controlled by a person in Mexico and running a web browser application, by which the person can navigate to the merchant's web site in the US and view and purchase the products at their transaction prices in a known way using a known kind of payment card (e.g. an Amex card, a MasterCard or a VISA card).

The overall system in FIG. 1 for completeness also includes a merchant acquirer system 106, which accepts and processes online transaction requests from the client system 102, a card scheme system 108 (for example, operated by VISA), and a card issuer system 110, the issuer being the party that issued the customer with the payment card. Also shown in FIG. 1 is one USD bank account of the client. The normal operating currency of each entity is also depicted in each block in parentheses FIG. 1. Arrows illustrating a typical order of events in an exemplary transaction are also illustrated in FIG. 1.

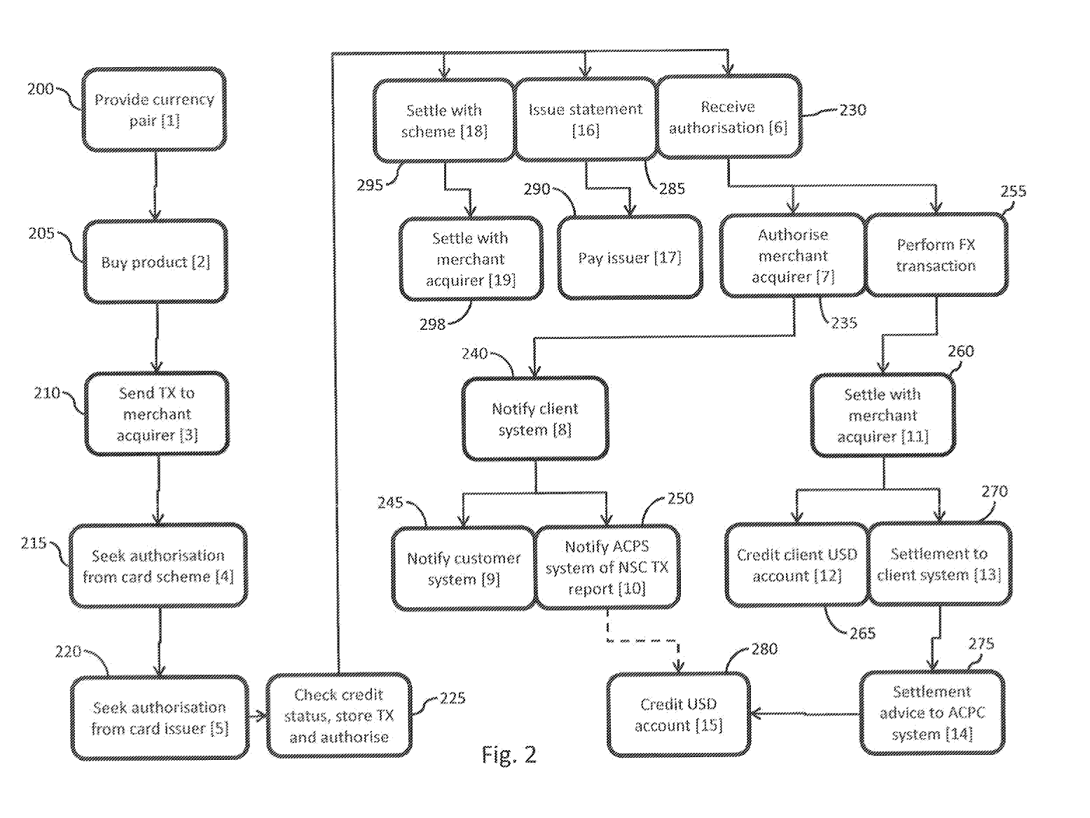

FIG. 2 is a flow diagram illustrating an exemplary payment transaction process, according to an embodiment of the present invention, conducted in the system of FIG. 1. Numbers in square brackets within the blocks of the flow diagram correspond to the transaction events (i.e. arrows) in FIG. 1. Blocks in the flow diagram which abut, side-by-side, relate to processes that each occur (although not necessarily at the same time) as a consequence of a previous process step.

In a first step, 200, the ACPC system 100 provides the client system 102 with a TLG exchange rate for a currency pair (in this example, USD/MXN). The client can then price its products in MXN, the local currency of the customers, for a certain period of time by applying the TLG exchange rate to the respective base prices, which are specified in the operating currency of the client. The TLG rates may be delivered to the client periodically and automatically or when requested by the client system 102. The TLG exchange rate may be accompanied by a flag or other indicator indicating that the rate is provided as a non-settlement currency (NSC) TLG exchange rate. As used herein, an NSC transaction is one in which the ACPC system provides a TLG exchange rate, for the certainty of the client and its customer(s), but is not called upon to perform an associated FX transaction, as will be described. The NSC indicator informs the client system 102 that the TLG exchange rate applies only to NSC transactions. If the client system 102 performs only NSC transactions then the NSC indicator may optionally be dispensed with. The TLG exchange rate may also be accompanied by an exchange rate identifier (ERI), which is generated by the ACPC system 100 as a unique reference identifying the respective currency pair and the rate applied at the respective time. The ERI may be formatted as a data string that embodies this information (in clear text or encoded form) or comprise a reference to an exchange rate database or history (not shown) updated by the ACPC system 100 whenever new rates are provided. In any event, the ERI can conveniently be used downstream by the ACPC system 100 to identify an exchange rate that was applied to a particular transaction.

It will be appreciated that the TLG exchange rate, the NSC indicator and the ERI may be formatted and communicated to the client system 102 in any appropriate manner, for example as multiple data packets or a single data packet containing all of the foregoing information.

In a second step 205, the customer, having seen a product that it wants to buy advertised on the web site for a transaction price in MXN, performs an online transaction in MXN, for example, by adding the product to an online shopping cart, providing his payment card details and pressing a “BUY” button.

In response, in step 210, the client system 102 communicates the transaction details to the merchant acquirer system 106, which, in step 215, seeks authorisation for the transaction from the card scheme system 108. In step 220, the card scheme system 108 seeks authorisation from the card issuer system 110. The card issuer system 110, in step 225, checks the credit status of the customer, stores the transaction details for future billing of the customer, and authorises the transaction in the normal way. It is assumed that the transaction is approved (rather than declined) for the sake of brevity.

Next, in step 230, the card scheme system 108 receives the authorisation, and, in step 235, communicates the authorisation to the merchant acquirer system 106.

The merchant acquirer system 106 then notifies the client system 102 of the authorisation in step 240 and, in step 245, the client system 102 notifies the customer system 104 that the requested transaction has been completed. In step 250, the client system 102 communicates a transaction report to the ACPC system 100.

The transaction report may for example comprise the following information:

transaction financial information such as ‘sell MXN1200 and buy USD100’,

an NSC indication, indicating that the transaction is an NSC transaction,

an ERI, which is used to identify the exchange rate that applies to the transaction and which was previously provided by the ACPC system 100,

a unique transaction identifier (UTI), generated by the client system.

The ACPC system 100 does not need to know the details of the transaction, for example, what was purchased.

The purpose of the UTI is so that the ACPC system 100 can match the transaction report with an associated settlement account, which is received later on, as will be described hereinafter.

The UTI, according to the present exemplary embodiment, is typically generated by the client system 102 according to a format specified by (and/or agreed in advance with) the ACPC system 100. For example, the UTI may comprise a twelve-digit alphanumeric string, including three characters or digits that identify the client and a nine-digit number that is incremented for each new transaction. The UTI may in addition, or instead, include a timestamp, indicating the time when the transaction was performed. Such a timestamp may, for example, be useable as another means, or an alternative means, to associate a transaction with a TLG exchange rate that applied to the transaction. Moreover, in embodiments in which an over-arching ACP system is capable of delivering (as need dictates) both normal FX transaction TLG exchange rates and NSC FX transaction TLG exchange rates, the UTI may take the same format for both normal and NSC transactions. In this case, the NSC indication may then comprise a flag, which is set ‘on’ (or 1) for an NSC transaction and ‘off’ (or 0) for a normal FX transaction. There are of course many other ways in which a transaction report may be formatted and communicated to the ACPC system 100.

In step 255, typically a period of time after the transaction was initially authorised, the card scheme system 108 performs a normal FX transaction to sell MXN currency and buy USD. The card scheme may perform the transaction directly, for example with a foreign bank, or use an intermediary to perform the FX transaction on its behalf. In the present example, the card scheme effectively sells MXN1200 and buys an amount of USD according to an exchange rate determined for the transaction. Typically, the exchange rate will be different from the TLG exchange rate supplied by the ACPC system 100. The exchange rates may be different—they could be more or less favourable to the client—for many reasons. For example, the card scheme may benefit from favourable spot rates, whereas the ACPC system 100 has to provide rates that are guaranteed for a period of time and may therefore be less favourable at certain times as exchange rates vary. Alternatively, the APCS system 100 or card scheme may perform higher volumes of FX transactions than the card scheme, and may benefit from better wholesale rates than the card scheme (or vice versa). In other instances, the card scheme may be able to attract similar (or even better) wholesale rates to the ACPC system, but may add a higher margin and/or offer less favourable rates to the client. There are many other reasons why the rates applied by the card scheme may be more or less favourable to the client than the TLG exchange rates.

In any event, for the present purposes and using the present values by way of example, the card scheme 106 sells MXN1200 and buys USD98. In other words, in this instance, the USD/MXN exchange rate is less favourable to the client than the TLG exchange rate supplied by the ACPC system 100.

In step 260, the card scheme system 108, applying the exchange rate it obtained, informs the merchant acquirer of the settlement and credits a USD account (not shown) of the merchant acquirer system 106. In step 265, the merchant acquirer system 106 credits the USD bank account 114 of the client with the resulting USD funds, in this example USD98, as a final, actual settlement for the transaction. The client would not have known this figure in advance—for example because the third party exchange rate for the normal FX transaction performed by the card scheme would not have been a DCC or TLG exchange rate. In step 270, the merchant acquirer system 106 provides the client system 102 with a settlement report indicating the actual settlement (USD98) credited to the client bank account 114.

The client system 102 receives the settlement report, matches it with the earlier transaction (for example using identification information provided by the merchant acquirer system 106) and generates a settlement advice for example comprising the following settlement information:

the same UTI as was used in the transaction report

the actual settlement value ‘USD98’

the third party exchange rate used by the card scheme for the normal FX transaction

In step 275, the client system 102 communicates the settlement advice to the ACPC system 100.

The ACPC system 100, receives the settlement advice and, using the UTI, reconciles the settlement advice against the transaction report that it received earlier (in step 250). The reconciliation performed by the ACPC system 100 effectively compensates the client for the respective shortfall in settlement. According to the present example, the reconciliation can be illustrated as:

Transaction report [e.g. Step 250]

“Buy USD100 and sell MXN1200”

(i.e. using TLG exchange rate 12)

Settlement advice [e.g. Step 270]

“Sell USD98 and buy MXN1200”

(i.e. using card scheme exchange rate 12.245)

Given this, the ACPC system 100 determines that the MXN portions of the transaction effectively cancel out (i.e. net to zero—as should typically be the case) and the USD portions of the transaction net to USD2. Consequently, in step 280, the ACPC system 100 credits the client's USD bank account with USD2, to compensate the client for the USD2 shortfall, due to the third party exchange rate employed by the card scheme having (in this example) been less favourable to the client than the TLG exchange rate.

At some point, in step 285, the card issuer system 110 causes generation of a statement, including the foregoing transaction (in MXN), which is sent to the customer and, in step 290, the customer settles with the card issuer (in MXN). In this way, the customer pays exactly the transaction price he was informed of at the point of payment. In addition, in step 295, the card issuer system 110 settles MXN1200 with the card scheme 108, which in turn settles MXN1200 with the merchant acquirer 106 in step 295.

In the foregoing example the ACPC system 100 is concerned only with a difference in exchange rates between the TLG exchange rate provided by the ACPC system 100 and the third party exchange rate employed by the card scheme system 108; the actual settlement being a function only of the transaction price and the third party exchange rate. In effect, the ACPC system 100 will (if necessary) compensate the client system 102 if there is a shortfall in the actual settlement due to an unfavourable exchange rate employed by the card scheme.

In most scenarios, one or more of the parties, for example the card scheme and/or the merchant acquirer, in the payment pipeline may levy a charge such as a commission, an additional FX margin and/or a fee for facilitating the transaction. Such charges may be fixed (i.e. per transaction) or variable, for example, depending on the size and/or number of transactions.

In some instances the or each charge may be levied independently of (i.e. not at the same time as) individual transactions, for example, as a separate payment (or payments) to the respective parties on a daily, weekly or monthly basis, and therefore will not influence the values of actual settlements. In this case, as in the foregoing example, the ACPC system will credit the client's bank account 114 with a value dependent only on the exchange rate (e.g. USD98, as in step 265), such that the actual settlement ‘98’ equals the transaction price ‘1200’ divided by the third party exchange rate ‘12.245’ applied, in this example, by the card scheme.

Indeed, in such cases, in principle the settlement advice would not need to include both the actual settlement and the exchange rate, since either could be derived from knowledge of the other and knowledge of the transaction price, which may be known to the client system 102 and the ACPC system 100.

In other instances, at least one (and perhaps more than one) charge may be levied within the payment pipeline, so as to influence (i.e. reduce) the actual settlement paid into the client's bank account 114. In this case, in contrast to the foregoing example, the actual settlement credited to the client's bank account 114 would typically be less than USD98, even when the third party exchange rate is the same.

In such a case, however, the ACPC system 100 may rely on the third party exchange rate information provided in the settlement advice to ensure that it is taking account only of exchange rate variances and not of any additional charges (if that is what has been agreed with a respective client).

According to other embodiments, the ACPC system 100 may be arranged to take account of one or more third party charges when setting its TLG exchange rates. For example, if it is known to the ACPC system 100 that the merchant acquirer system 106 deducts a MXN1 fee for each transaction and/or the card scheme levies a 0.5% commission on the value of each transaction, the ACPC system 100 may determine its TLG exchange rates taking account of the charges, effectively, to guarantee the actual settlement that is credited into the client's bank account 114. In such circumstances, a TLG exchange rate can be thought of as an ‘effective exchange rate’, which is generated to accommodate a third party exchange rate in addition to some or all third party charges that arise in the payment pipeline. According to some embodiments, therefore, the ACPC system 100 may be arranged to compensate the client for a shortfall in overall actual settlement—due, for example, to adverse exchange rates and charges—rather than just for the elements of the actual settlement that are attributable to exchange rate variances.

In other words, the ACPC system 100, in determining its TLG exchange rates, is capable of factoring in not only a different exchange rate that will most likely be employed by the card scheme but also any charges deducted by at least one party in the payment pipeline (including taking account of whether charges are deducted before or after the FX transaction is performed), which results in a reduced actual settlement being credited to the client's bank account 114. Moreover, an ACPC system according to embodiments of the invention can operate to compensate a client irrespective of whether the charges that are applied by the payment pipeline are published (i.e. explicitly known to the ACPC system) or not. In the latter case, when charges are not published, the ACPC system can adapt to compensate for the application of the unknown charges by reference to settlement value alone, as will be described.

The exact nature of a TLG exchange rate, in terms of whether or not the rate takes account of just third party exchange rates or whether one or more other charges are factored in, may be agreed on a client by client basis. The TLG exchange rate may be presented as a market-related FX rate (e.g. a rate that tracks the market and/or a particular market index in some way) plus a margin, where the margin may be varied depending on what factors the TLG exchange rate has to accommodate. As will be described, a TLG exchange rate may optionally also be provided taking into account a number of additional or alternative factors, as will be described below.

In general terms, it will be appreciated that an ACPC system according to embodiments of the present invention does not have any control over the third party exchange rates that are employed by a card scheme to perform a normal FX transaction or over any charge(s) that may be levied by one or more parties in the payment pipeline. The card scheme does not provide DCC and so neither the client nor the ACPC system has knowledge, at the point of payment by the customer, of the third party exchange rate that will be applied by the card scheme. The ACPC system provides TLG exchange rates that protect clients from future exchange rate movements, while factoring in (if required) any charges levied by parties in the payment pipeline. To achieve this, an ACPC system according to embodiments of the present invention must therefore be arranged to accommodate a far greater degree of uncertainty and risk compared with known kinds of ACPS system, which provide TLG exchange rates in addition to performing the respective FX transactions (i.e. known ACPS systems effectively only back their own FX rates rather than those of other parties) in the payment pipeline.

Beneficially, through use of an ACPC system according to embodiments of the present invention, clients and their customers are able to enjoy the same degree of certainty (and reduced level of risk) as they already enjoy under scenarios employing known ACPS systems, even when they use third parties (for example, card schemes) to perform their normal FX transactions.

Although according to the examples illustrated with reference to FIG. 1 the card scheme is responsible for the FX transaction, there is no reason in principle why the FX transaction could not be performed by an alternative third party, for example the card issuer, the merchant acquirer, or a bank, broker or other intermediary operating on behalf of any one of those entities. As already mentioned, any one or more of the foregoing parties may also levy a charge of some kind for performing or facilitating a transaction. Embodiments of the present invention may be arranged to accommodate all such alternatives.

Although the foregoing example illustrates an exemplary process for a single transaction, it will be appreciated that, in practice, the various players and process steps would tend to process and settle multiple transactions in one go.

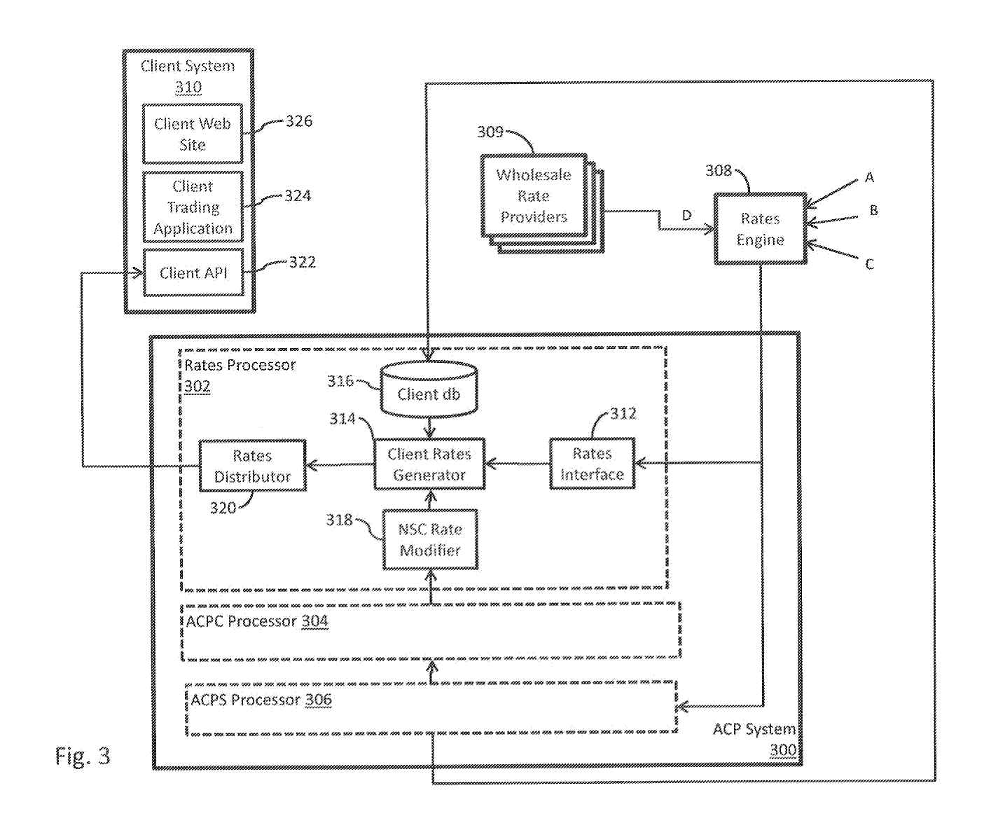

An ACPC system according to one exemplary embodiment of the present invention will now be described in greater detail with reference to FIGS. 3 to 5. The functionality of the ACPC system is described in the context of an over-arching ACP system 300, according to the following exemplary embodiment, which has the capability of handling both normal FX transactions (through ACPS functionality realised by an ACPC processor 304) and NSC transactions (through ACPC functionality realised by an ACPS processor 306). The term ‘processor’ is used for convenience herein in the broadest sense to encompass any one or more of a software programme executing on a computing device, platform or apparatus to perform one or more processes, a hardware device programmed with instructions to perform one or more processes, a standalone computing device, platform or apparatus programmed to perform one or more processes or an arrangement comprising more than one computing device, platform or apparatus programmed to perform one or more processes.

According to FIG. 3, the exemplary ACP system 300 comprises a rates processor 302, the ACPC processor 304 and the ACPS processor 306, each of which will be described is greater detail below. Also illustrated are an exemplary rates engine 308 and an exemplary client system 310, each of which is separate from the ACP system according to the present example. The rates engine 308 is a source of exchange rates for various currency pairs that are supported by the ACP system 300 and is communicatively coupled to the ACP system 300 to deliver the rates thereto in a known way, for example as data packets via a communication network.

The exchange rates are delivered by the rates engine 308 to the ACP system 300 when the rates are requested by the ACP system 300, for example, in response to a request for respective rates made by a client system 310. Client systems may request rates periodically, for example hourly or daily, although other periods could be utilised. Alternatively, or in addition, one or more of the rates could be delivered on an ad hoc basis, for example whenever a significant rate movement is detected.

In the example of an ACP system 300 operable in the US, with USD as the operating currency, the TLG exchange rates offered to clients by the ACP system 300 typically comprise just the rates at which the ACP system 300 will ‘sell’ USD in exchange for buying any other supported currency. In other words, it is not normally necessary to offer a client a full buy/sell spread, since the client will typically only need to receive/buy USD. The full buy/sell spread may, however, be needed by a client which buys as well as sells products, or a client which handles purchases on behalf of a third party (e.g. an auction web site), and some embodiments of the invention can accordingly offer of the full buy/sell spread.

In any event, according to the present embodiment, the rates engine 308 receives exchange rate information feeds from at least one source, but preferably from more than one source, for example rate providers A-D. Sources may be public sources of rate information and/or comprise at least one source of wholesale rates (but potentially multiple sources of wholesale rates offered by multiple wholesale rate providers 309). Wholesale rates are typically only available for high value transactions, which typically emanate from banks and larger corporations rather than from smaller corporations, merchants or individuals. The rate providers A-D typically provide rates across a wide range of currency pairs, although the rate providers may choose to limit the rates provided to a limited range of currency pairs. However, by obtaining rates from a range of providers it is possible to obtain rates for all currency pairs likely to be the subject of significant volumes of transactions. The frequency with which the wholesale rates are obtained will typically depend upon the volatility of the market, and may vary from currency pair to currency pair, but may be for example every hour. The rate information may comprise spot rates and/or futures rates, to be used in the provision of TLG exchange rates.

The rates engine 308 uses the rate information to generate a single exchange rate for each currency pair supported by the ACP system 300. The rates engine 308 may use blending, which, for each currency pair, calculates the degree in variation between rates from rate provider to rate provider, and issues a blended rate which is representative of the state of the market, and serves as a predicted rate. The predicted rate is used as the basis for rates communicated to clients, for the purposes of calculating the foreign exchange rates which will be applied to the transactions corresponding to the client during a given time period (for example 24 hours or until the next wholesale rate update and rate blending is carried out again).

According to the present embodiment, the rates engine 308 is not guaranteeing exchange rates for the ACP system 300. Rather, the rates engine 308 is providing a baseline set of exchange rates, which the rates processor 302 uses for generating respective client TLG exchange rates.

In this example, clients comprise at least online merchants but could in addition or instead comprise foreign money transfer entities or any other kind of entity that requires a TLG exchange rate for its operations. If the rates engine 308 and the APCS system 300 are operated within a single financial institution, the rates engine 308 may generate its rates and also feed the rates into a trading system (not shown), which implements various hedging strategies to compensate for potential losses, for example due to adverse exchange rate fluctuations, which could otherwise arise from the ACP system 300 having guaranteed its exchange rates with clients.

As already indicated, according to the present embodiment, the rates engine 308 is separate from the ACP system 300. The rates engine 308 and the ACP system 300 may be operated by a common financial institution or they may be controlled and operated by different financial institutions. On the other hand, in principle, a rates engine or equivalent could be a subsystem or module of the APC system.

According to the present embodiment, the ACP system 300 receives the rates at a rates interface 312, which feeds the rates to a client rate generator 314.

The client rate generator 314 determines TLG exchange rates on a client by client basis, for example, by applying a margin to rates received from the rates engine 308. As already explained, the margin may be based on a number of factors, some of which have already been described above in relation to whether or not the ACP system takes account of charges levied by one or more parties in the payment pipeline.

TLG exchange rates (or, rather, the margins that are applied to generate the TLG exchange rates) may in addition or alternatively be influenced by certain other client-specific information, which is stored in a client database 316. For example, each client may negotiate a duration for which its respective rates will remain valid. The duration may be, for example, 24 hours or 48 hours, but could be shorter or longer, for example up to one or even two weeks. The duration will typically have a direct impact on a margin that is applied to generate a TLG exchange rate, with longer durations typically being associated with a higher degree of risk (in terms of exchange rate movements) and higher margins.

Other client-specific information may relate to the expected volume of trades performed by each client, which may be updated from time to time based on actual transaction data delivered by the ACPS processor 306 (as described below). For example, a client that historically performs a large volume of trades may be offered better client TLG exchange rates than a client that performs a relatively lower volume of trades. The client-specific information may in addition, or alternatively, comprise any credit risk involved in trading with the client, with riskier clients (or newer clients having no trading history) attracting less favourable TLG exchange rates (at least to begin with or until a favourable trading history is established). Moreover, client-specific information may specify a gross profit margin to be applied, for example by way of a wider TLG exchange rate spread. Such a gross profit margin may be for the benefit of the ACP system and/or for the benefit of the client. In any event, a gross profit margin that is factored in is typically negotiated with each client. Of course, a profit would typically only accrue in transaction instances when the ACP system is not required to compensate the client system.

Accordingly, a tailored TLG exchange rate (comprising, for example, a rate provided by the rates engine plus a margin that accommodates all of the client-specific information) is made available for each currency pair to each client. The margin may be fixed by agreement with the client and may be renegotiated periodically, for example, as agreed and/or as circumstances (e.g. increasing volumes of client trades, increased market volatility, etc.) dictate.

According to some embodiments of the invention, the client rates generator 314 also optionally takes into account information from an NSC rate modifier 318. The NSC rate modifier 318 is responsible for adjusting client rates to take into account added uncertainty introduced by clients which use a third party to perform FX transactions, as will be described.

The exchange rates may be adjusted by the NSC rate modifier 318 in various ways. For example, the NSC rate modifier 318 may introduce a wider spread on the standard exchange rate spread, to take account of the added uncertainty and/or additional charges introduced by parties in the payment pipeline. As already described, such charges may be published (i.e. known to and factored in by the ACP system) or unpublished. The NSC rate modifier 318 may itself be fed by NSC information received from the ACPC processor 304, which, as will be described according to an exemplary embodiment, feeds back to the NSC rate modifier 318 information relating to the performance of the ACP system. In this way, client TLG exchange rates can be adjusted dynamically based on the nature of the client and also based on NSC information (for those clients that use the NSC capability) of the ACP system 300. If a particular TLG exchange rate includes a margin that has been fixed by agreement with a client, the NSC rate modifier 318 may instead act as a trigger to consider renegotiating the margin with the client rather than acting to adjust the rate automatically (i.e. without the client's approval).

TLG exchange rates for each client are communicated from the client rates generator 314 to a rates distributor 320, which communicates the respective rates, as data packets (or in any other appropriate manner), to the respective clients via one or more communications networks. These client exchange rates are TLG exchange rates, insofar as they are fixed and will be guaranteed by the ACP system 300 for all client transactions that are performed within the associated timeframe, which is, according to the present example, 24 hours.

Each client has a system 310 (only one of which is shown for convenience), which typically comprises at least a client application programming interface (API) 322, a client trading application 324 and a client web site server 326, each of which is typically realised in software. The client API 322 is arranged to interpret the rate information received from the ACP system 300, and distribute that information to the client trading application 324 and the client web site server 326. In this way, the client system 310 can offer products online in each of the currencies for which it receives exchange rate information.

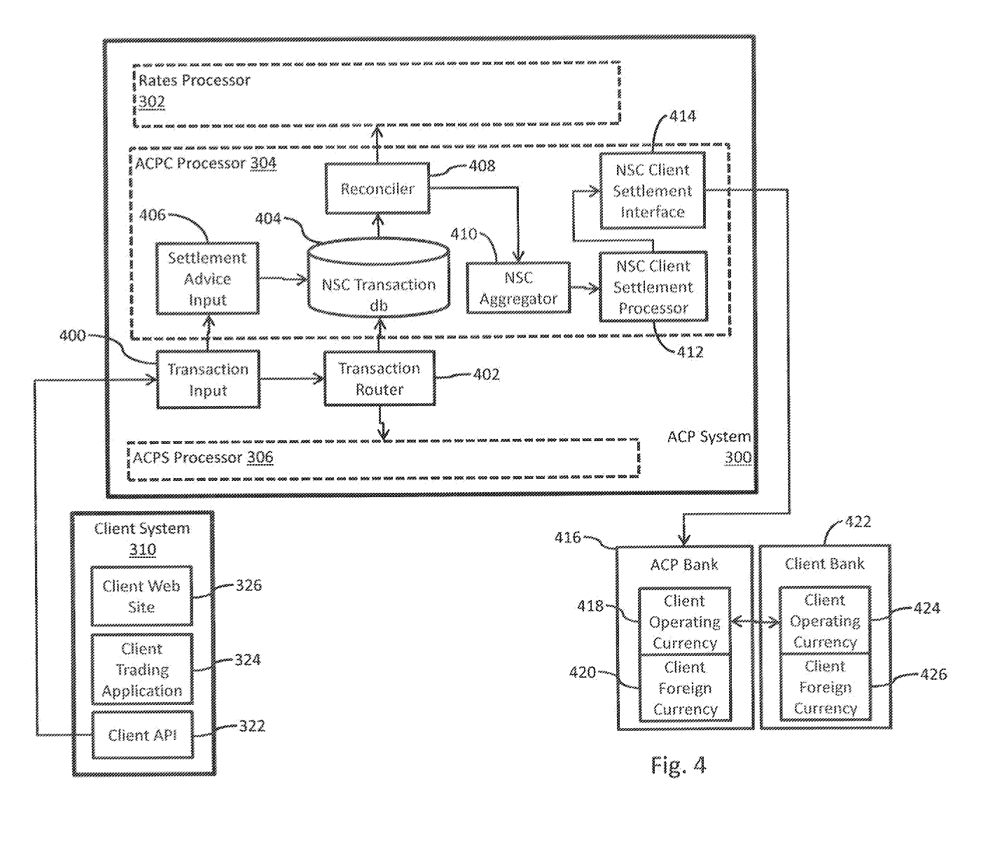

According to FIG. 4, which focuses on the elements within the exemplary ACPC processor 304, the ACP system 300 comprises a transaction input 400, which is arranged to receive client transaction information, via the client API 322, from all client systems 310 that use the ACP system 300. According to the present example, at least three kinds of transaction information can be received, as follows:

Normal FX Transaction Information

This information relates to normal FX transactions (that is, non-NSC transactions) and may comprise a transaction report of the kind described above. The transaction report typically includes at least information sufficient to enable the ACPS processor 306 to determine the client identity and the transaction price. The information typically also includes an ERI, to enable the ACPS system 306 to determine which TLG exchange rate applies to the respective transaction.

NSC Transaction Information

This information relates to NSC transactions and may comprise a transaction report of the kind described above. The transaction report typically includes at least the same information as a transaction report for a normal FX transaction (that being, information sufficient to enable the ACPC processor 304 to determine the client identity, the transaction price and the TLG exchange rate, for example, using an ERI) and, in addition, a flag indicating that the transaction is an NSC transaction (rather than a normal FX transaction) and a UTI.

NSC Settlement Information

This information relates to NSC transactions and, specifically, to a settlement advice of the kind described above. The settlement advice typically includes at least a UTI, which is used by the ACPC processor 304 to match the NSC settlement information with the respective NSC transaction report that had previously been received, and information sufficient to enable the ACPC processor 304 to determine the actual settlement that was credited to the client to settle the transaction. The exchange rate applied by the third party exchange rate provider may also be provided; although, as has already been described, in instances in which a settlement is a function only of an exchange rate applied, for example, by a card scheme (and not a function of any added charges) one or other of the actual settlement and exchange rate may be deduced from knowledge of the other and the transaction price in the operating currency of the customer. The exchange rate information applied by the card scheme (or other third party) may also not be required in instances in which the TLG exchange rate is an effective exchange rate, which takes account of the third party exchange rate in addition to charges applied by one or more of the parties in the payment pipeline.

According to the present embodiment, the transaction input 400 determines whether the received information relates to a transaction report or to a settlement advice. If the information relates to a transaction report, the information is transmitted to a transaction router 402. The transaction router 402 determines if the information relates to a normal FX transaction or an NSC transaction, for example by reference to an NSC identifier flag being set or not. Information relating to a normal FX transaction is communicated to the ACPS processor 306 (for processing as described below), whereas information relating to an NSC transaction is communicated to an NSC transaction database 404 in the ACPC processor 304. If the information relates to a settlement advice it is communicated to a settlement advice input 406 of the ACPC processor 304, which in turn stores the settlement information in the NSC transaction database 404. The NSC transaction database 404 associates and stores received NSC settlement advices with previously-received NSC transaction reports.

Periodically, for example each hour or each day, a reconciler 408 accesses the NSC transaction database 404 and, for each client and using respective UTIs, reconciles NSC transaction reports and their respective NSC settlement advices.

According to the present embodiment (in which it is assumed that no charges are incurred in the payment pipeline), the step of reconciliation effectively compares for each associated transaction the associated TLG exchange rate applied by the ACP system 300 with the third party exchange rate applied by the third party exchange rate provider. If the exchange rate applied by the third party exchange rate provider was favourable to the ACP system 300, according to the present example meaning the transaction price indicated by the NSC transaction report is less than the actual settlement indicated by the NSC settlement advice, the ACP system 300 effectively identifies the excess amount as a surplus in respect of the associated client. If, however, the exchange rate provided by the third party exchange rate provider was not favourable to the ACP system 300, according to the present example meaning that the transaction price indicated by the NSC transaction report exceeded the actual settlement indicated by the NSC settlement advice, the ACP system 300 records the shortfall as a deficit in respect of the associated client.

In other embodiments in which TLG exchange rates are effective rates, whereby the ACP system accounts for charges that are levied in the payment pipeline in addition to the third party exchange rate applied by, for example, the card scheme, reconciliation may alternatively compare an expected settlement with an actual settlement, with the difference being an identified surplus or deficit.

In principle, it would be possible for the ACP system 300 to adjust a client account balance by crediting a client account each time a NSC transaction conducted for that client results in a shortfall to compensate for or correct the settlement. Equally, it would be possible to adjust a client account balance by debiting the client account each time a transaction conducted for that client results in an excess settlement. However, as will now be described, it is possible to employ aggregation to reduce the number of corrective debits and credits that may be required.

After reconciliation, for each client, an NSC aggregator 410 aggregates a number of transactions (for example, where the number is a threshold number or is determined according to a certain time period or value), in order to determine a net position across the transactions, and passes respective information to an NSC settlement processor 412. The NSC settlement processor 412 generates an associated debit or credit instruction depending on whether the net position for the respective client is in surplus or deficit. The debit or credit instruction is passed to an NSC settlement interface 414, which adjusts a respective client bank account balance by issuing an instruction to debit or credit a respective client account 418 (in the operating currency of the respective client) of an associated ACP bank 416. Periodically, the ACP bank 416 issues a credit or debit instruction to adjust the account balance of a respective bank account 424 (in the operating currency of the client) of a respective client bank 422. Alternatively, given appropriate authorisations, the ACP system 300 may adjust client balances by crediting and debiting client bank accounts directly, thereby obviating client accounts within an ACP bank. In other embodiments still, the ACP system 300 may instead issue to the client an invoice (or credit note), which the client is required to settle.

In this way, each client account balance is corrected periodically for any net deficit incurred due to unfavourable NSC transactions or net surplus due to favourable NSC transactions, by being placed in the position it would have been in had the transactions been normal FX transactions conducted by a known kind of ACPS system.

It will be noted, according to some examples, that the reconciler 408 also passes information to the rates processor 302 (in particular to the NSC rate modifier 318), to be used, if necessary, to modify TLG exchange rates (or the margins applied thereto) and thereby maintain an appropriate balance between surplus and deficit, which is typically a net positive (or surplus) position. In this way the information can be used by the ACP system to modify (or trigger renegotiation of) its NSC TLG exchange rates dynamically and/or predictively. This is one means by which the rates processor 302 can take into account unpublished charges by adjusting any TLG exchange rates, which are effective rates including such charges.

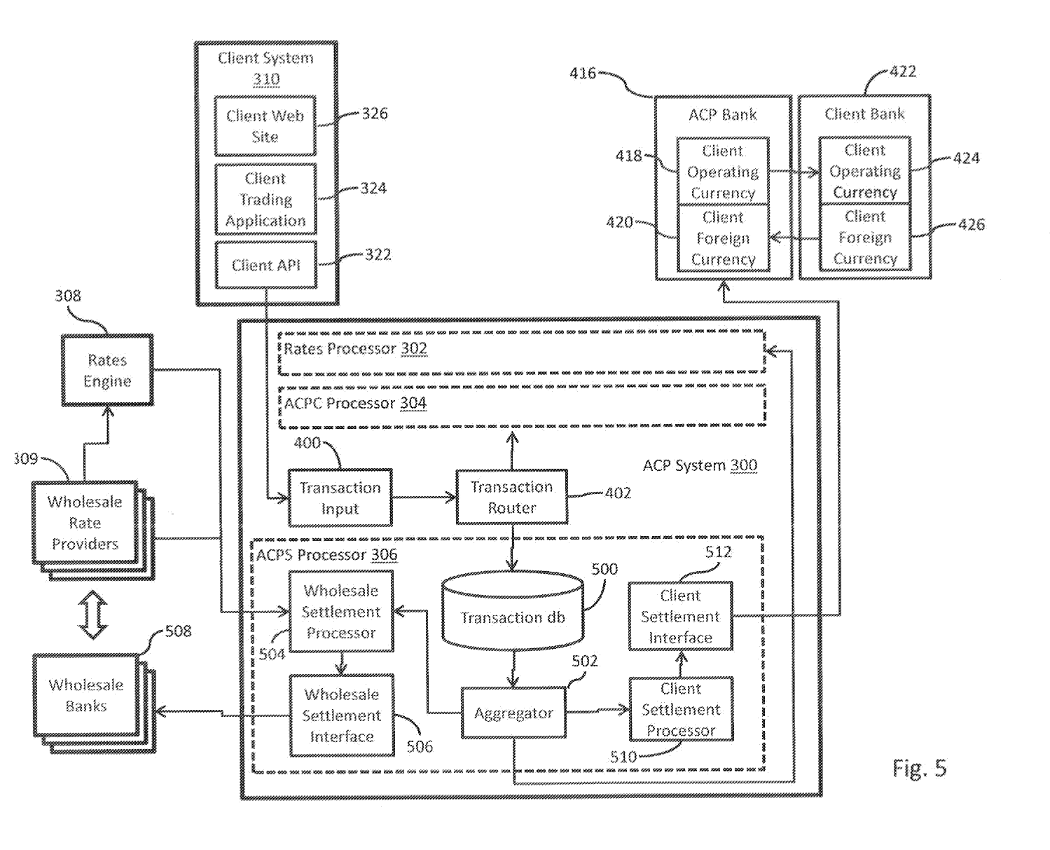

The ACPS processor 306, which is illustrated in greater detail in FIG. 5, generally functions as a known kind of ACPS system to perform normal FX transactions for clients. According to FIG. 5, the ACPS processor 306 comprises a transaction database 500, which is arranged to receive normal FX transaction information from the transaction router 402 (as described above). The transaction database 500 is arranged to feed the transaction information to an aggregator 502, which aggregates transactions on a per client basis across each currency pair. Each client thereby has a net position for each currency pair that it utilises. A wholesale settlement processor 504 is arranged to receive the aggregated client rate information and net transactions across multiple clients. The result is a net position in each currency pair. This enables long positions in one currency pair from one client to be offset against short positions in the same currency pair from another client. In this way the wholesale settlement processor 504 can continuously calculate and update for the ACP system 300 an instantaneous position in each currency pair. Because of the netting which occurs, frequently a client position (or portions of positions) may be settled internally, without the need to execute transactions (and be subjected to associated margins or commissions) with wholesale banks, thereby providing a more efficient system in which reduced margins can be applied to TLG exchange rates.

The wholesale settlement processor 504 frequently obtains rates from the rate providers (for example, conveniently, via the rates engine 308 or directly from the wholesale rate providers 309). Once a threshold level has been reached in a currency position to make a wholesale trade feasible, the best wholesale rate is selected from the rate providers 309, and the wholesale settlement processor 504 instructs execution of a wholesale settlement trade, via wholesale settlement interface 506. The wholesale settlement processor 504 instructs settlement with a wholesale settlement bank 508 associated with the best rate provider 309 at that point in time, thereby to settle the position in that currency pair. In this way the ACP system 300 takes advantage of the best wholesale rate, which (barring significant adverse FX rate movements) is likely to be better than the TLG client rates.

The aggregator 502 is also arranged to feed aggregated transaction information to a client settlement processor 510. The client settlement processor 510 periodically calculates an overall net position for each client, in the operating currency of the client, based on the transaction information and the associated TLG exchange rates that were applied. The client settlement processor 510 then generates client settlement instructions, which are sent via a client settlement interface 512 to the ACP bank 416. The instructions cause the ACPC bank 416 to transfer:

foreign currency from the respective client foreign currency account 426 of the client bank 422 into the ACP foreign currency account 420 of the ACP bank 416; and

client operating currency from the client operating currency account 418 of the ACP bank 416 into the client operating currency account 424 or the client bank 422.

Such settlements may take place, for example, daily or weekly. In this way, periodically, each client obtains payments in its operating currency equivalent to the value of the transactions (in all currencies) that were performed using the respective TLG exchange rates.

The aggregator 502 is also arranged to feed aggregated transaction information to the rates processor 302, in particular to the client database 316, so that the client database has an up-to-date record of client transaction activity, in order that it can accurately influence client TLG exchange rates determined by the client rates generator 314 (as described above).

Irrespective of how the TLG exchanges rates are determined, there are a number of alternative methodologies for handling when and whether to compensate a client. As has already been alluded to above, the selected methodology will typically be negotiated with a client on a case-by-case basis. For example, one option (as has been described above) is that the APC system 300 will compensate a client for a shortfall in a settlement (for whatever reason). If in the alternative the transaction is favourable to the ACP system, any surplus may be retained by the ACP system as a profit. An alternative option is that only a part of a shortfall is compensated by the ACP system. For example, if a shortfall is USD2, the ACP system may compensate the client by 50% of the shortfall (i.e. USD 1) and thereby share the risk and at the same time reduce the loss to the ACP system. As an additional (or alternative) option, the ACP system 300 and client may share any upside surplus according to an agreed formula. Further, the client and ACP system may share upside surplus and downside deficit in other agreed ways. Embodiments of the invention accommodate all manner of different compensation arrangements and compensation/profit apportionments, the details of which are typically negotiated with individual clients.

As has already been described, embodiments of the invention find utility with online merchants and money transfer organisations. In addition, embodiments of the invention find utility with any organisations which have to handle FX transactions, such as airlines, travel agents, online gaming providers, credit card processors, credit card networks, operators of automated teller machines that deliver foreign currency (e.g. located at an airport), providers of mobile wallets that are arranged to facilitate foreign currency payments and receipts, pre-pay bank card providers, and the like.

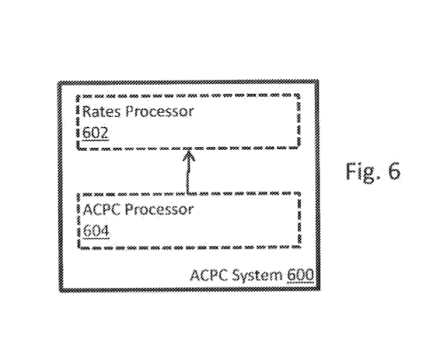

The above embodiments are to be understood as illustrative examples of the invention. Further embodiments of the invention are envisaged. For example, while the ACP system described above with reference to FIGS. 3 to 5 has the capability to handle both normal and NSC transactions, other embodiments of the present invention, as illustrated in FIGS. 1 and 6, are arranged to perform only NSC transactions. For example, according to FIG. 6, an ACPC system 600 according to an embodiment of the present invention comprises a rates processor 602 and an ACPC processor 604, each, for example, arranged generally to perform the functions attributed to the rates processor 302 and the ACPC processor 304 that are depicted in and described in detail with reference to FIGS. 3 to 5. In such a system, all inbound transaction requests would be known to relate to NSC transactions. Accordingly, such a system could dispense with mechanisms (for example, NSC flags or similar) by which the system could differentiate between NSC and normal FX transactions.

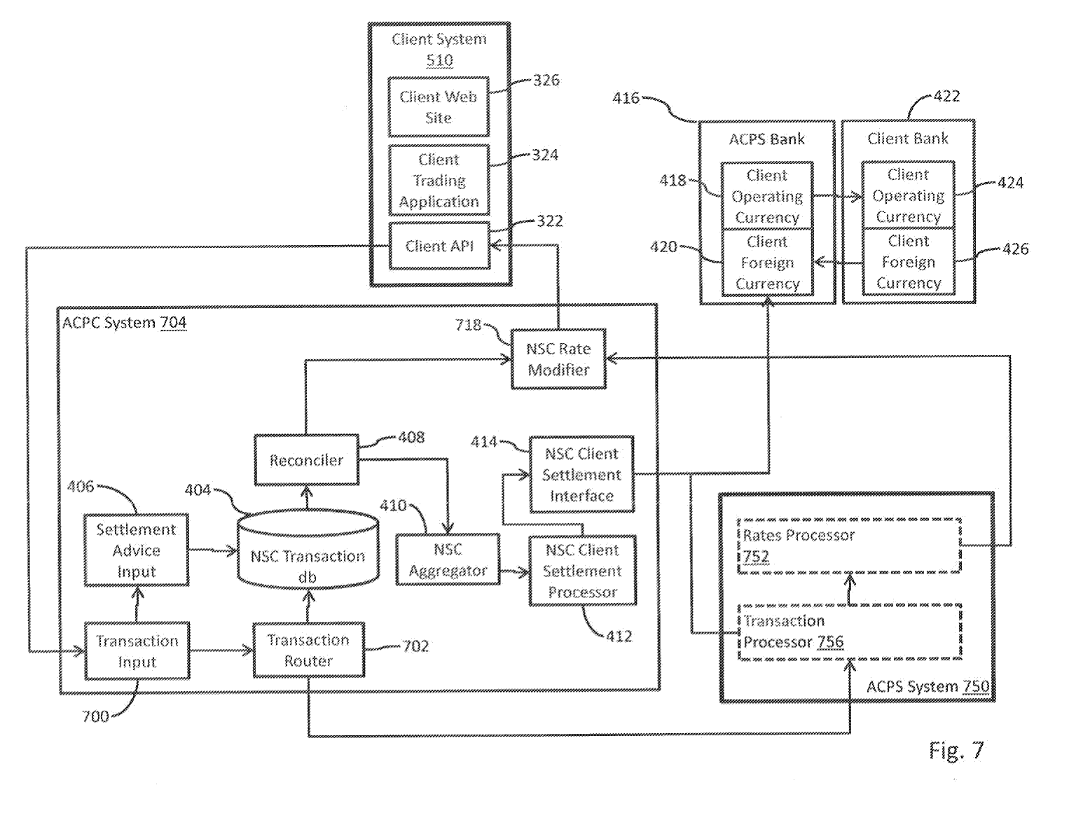

Yet other embodiments of the present invention, as exemplified in the diagram in FIG. 7, comprise an ACPC system 704. The ACPC system 704 may comprise a standalone system or comprise one or more software applications running on a shared computing apparatus. In either event, the ACPC system 704 can be arranged to perform the functions that are generally attributed to the ACPC processor 304, which is depicted in and described with reference to FIGS. 3 to 5: for convenience, certain elements in the ACPC system 704 are identified using the same reference numerals as equivalent elements (which operate in a similar manner) in the ACPC processor of FIG. 4.

Such an ACPC system 704 can be arranged to operate with another system 750 (for example a known kind of ACPS system) that is arranged to process only normal FX transactions and provide a source of exchange rates. In such an arrangement, for example, a client API 322 of a client system 310 may be adapted to send all transaction information (for both normal and NSC transactions) to a transaction input 700 of the ACPC system 704. A transaction router 702 routes NSC transactions to an NSC transaction database 404 and normal FX transactions, externally via a communications network, to the ACPS system 750.

The client API 322 may also be adapted to receive exchange rate information from an NSC rate modifier 718 of the ACPC system 704. The ACPC system 704 receives normal client exchange rates into the NSC rate modifier 718, which either modifies the normal rates to become NSC rates before passing them to a client, or passes the normal rates on to a client, depending on the needs of the client. NSC rates are adapted, for example, using information received from a reconciler 408, as described above, and a client database (not shown) holding client-specific information. Other operations of the ACPC system 704 are generally the same as the operations described with reference to FIGS. 1 to 5.

The ACPC system 704 of FIG. 7 effectively augments a known ACPS system 750 so that the overall system is capable of processing both normal and NSC transactions. In general, it will be appreciated that an ACPC system 704 may be adapted to interact with and/or augment a known ACPS system 750 in various different ways, aside from in the foregoing ways. However, beneficially, the foregoing example is perceived to require minimal or no alterations to the operation of the known ACPS system 750.

It is to be understood that any feature described in relation to any one embodiment or example may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

For the avoidance of doubt, and as the skilled person would know, computing terms such as ‘processor’, ‘engine’, ‘system’, ‘module’ and the like are used herein broadly to encompass any appropriate arrangement of hardware and/or software configured and arranged to perform the functions that are attributed to the respective items. The terms may also be used interchangeably and are used herein broadly to encompass any kind of programmed or programmable computing entity, for example a personal computer or server or mobile computing device, which may be programmed to provide the functionality of a foregoing ‘processor’, ‘engine’, ‘system’ or ‘module’.

What is claimed is:

1. A computerised system comprising:
a processor configured to:
format one or more data packets to include a time-limited guaranteed exchange rate between a first currency and a second currency for a purchase transaction;
provide the one or more data packets to a client system;
receive, from the client system, a client transaction report, which includes a transaction identifier and information indicating a transaction price in the second currency for performing the purchase transaction;
receive, from the client system, a settlement advice, which includes the transaction identifier and information indicating an actual settlement value for the purchase transaction in the first currency, the actual settlement value being based on the transaction price and a third party exchange rate between the first currency and the second currency used to actually perform the purchase transaction;
match, using the transaction identifier, the client transaction report to the settlement advice;
determine, based on the match, a difference between the actual settlement value and an expected settlement value for the purchase transaction in the first currency, wherein the expected settlement value is based on the transaction price and the time-limited guaranteed exchange rate, such that any difference between the actual settlement value and the expected settlement value is at least in part due to a difference between the time-limited guaranteed exchange rate and the third party exchange rate; and
adjust a client account balance based on the difference between the actual settlement value and the expected settlement value.

2. The system according to claim 1, wherein the processor is configured to credit the client account balance for at least a portion of any shortfall in the actual settlement value compared with the expected settlement value.

3. The system according to claim 1, wherein the processor is configured to debit the client account balance for at least a portion of any surplus in the actual settlement value compared with the expected settlement value.

4. The system according to claim 1, wherein, for a client associated with the client account balance, the processor is configured to aggregate a plurality of determined differences between actual settlement values and expected settlement values to produce a net actual settlement position and, where necessary, credit or debit the client account balance of the client by at least a portion of any respective deficit or surplus in the net actual settlement position.

5. The system of claim 1, wherein the processor is further configured to generate the time-limited guaranteed exchange rate, and wherein the transaction price is based on the time-limited guaranteed exchange rate.

6. The system of claim 5, wherein the processor is configured to determine the time-limited guaranteed exchange rate based on client-specific information.

7. The system according to claim 5, wherein the processor is configured to generate an exchange rate identifier comprising a reference to identify the time-limited guaranteed exchange rate, and provide said exchange rate identifier to the client system with the time-limited guaranteed exchange rate.

8. The system of claim 5, wherein the processor is configured to provide the time-limited guaranteed exchange rate to the client system with an indicator to indicate that client transactions which use the time-limited guaranteed exchange rate are non-settlement currency transactions.

9. The system of claim 1 arranged to perform the functions of an advance currency pricing and compensation system.

10. An advance currency pricing system, comprising:
a generator to generate time-limited guaranteed exchange rates for clients;
an advance currency pricing and compensation processor, comprising:
a first processor to determine a difference between an actual settlement and a respective expected settlement for each of a plurality of client transactions, each client transaction having an expected settlement in a first currency and a transaction price in a second currency under which the transaction is performed, the transaction price being determined from the expected settlement using a respective time-limited guaranteed exchange rate between the first and second currencies, and each actual settlement in the first currency being determined from the transaction price using a third party exchange rate, such that for each client transaction any difference between an actual settlement and a respective expected settlement is at least in part due to a difference between the time-limited guaranteed exchange rate and the third party exchange rate; and
a second processor to adjust, for each client transaction, a respective client account balance according to said difference; and
an advance currency pricing and settlement processor, comprising:
a first processor to receive information relating to a client transaction comprising a transaction price in a second currency, determined from a base price in a first currency using a time-limited guaranteed exchange rate;
a second processor to perform at least one foreign exchange transaction between first and second currencies to accommodate said client transaction; and
a third processor to debit a first client account according to the transaction price in the second currency and credit a second client account according to the base price in the first currency.

11. A method of settling client transactions, comprising:
formatting, using a processor, one or more data packets to include a time-limited guaranteed exchange rate between a first currency and a second currency for a purchase transaction;
providing the one or more data packets to a client system;
receiving, from the client system, a client transaction report, which includes a transaction identifier and information indicating a transaction price in the second currency for performing the purchase transaction;
receiving, from the client system, a settlement advice, which includes the transaction identifier and information indicating an actual settlement value for the purchase transaction in the first currency, the actual settlement value being based on the transaction price and a third party exchange rate between the first currency and the second currency used to actually perform the purchase transaction;
matching, using the processor, using the transaction identifier, the client transaction report to the settlement advice;
determining, using the processor, based on the matching, a difference between the actual settlement value and an expected settlement value for the purchase transaction in the first currency, wherein the expected settlement value is based on the transaction price and the time-limited guaranteed exchange rate, such that any difference between the actual settlement value and the expected settlement value is at least in part due to a difference between the time-limited guaranteed exchange rate and the third party exchange rate; and
adjusting, using the processor, a client account balance based on the difference between the actual settlement value and the expected settlement value.

12. The method of claim 11, comprising crediting the client account balance for at least a portion of any shortfall in the actual settlement value compared with the expected settlement value.

13. The method of claim 11, comprising debiting the client account balance for at least a portion of any surplus in the actual settlement value compared with the expected settlement value.

14. The method of claim 11, comprising, for a client associated with the client account balance, aggregating a plurality of determined differences between actual settlement values and expected settlement values to produce a net actual settlement position and, where necessary, crediting or debiting the client account balance of the client by at least a portion of any respective surplus or deficit in the net actual settlement position.

15. The method of claim 11, comprising generating the time-limited guaranteed exchange rate, and wherein the transaction price is based on the time-limited guaranteed exchange rate.

16. The method of claim 15, comprising determining the time-limited guaranteed exchange rate based on client-specific information.

17. The method of claim 15, comprising generating an exchange rate identifier comprising a reference to identify thee time-limited guaranteed exchange rate, and providing said exchange rate identifier to the client system with the time-limited guaranteed exchange rate.

18. The method of claim 17, comprising providing the time-limited guaranteed exchange rate to the client system with an indicator to indicate that client transactions which use the time-limited guaranteed exchange rate are non-settlement currency transactions.
